(19) United States
(12) Patent Application Publication
(10) Pub. No.: US 2011/0295880 A1
(43) Pub. Date: Dec. 1, 2011

(54) PROCESS FOR MONITORING THE SUCCESS OF THE ADMINISTRATION OF A FLUID TO A NON HETEROGENOUS BIOLOGICAL TARGET, AND SYSTEM THAT ENABLES THE EXECUTION OF SAID PROCESS

(76) Inventors: Antonio Casanova Tavares Travasos, Coimbra (PT); Armanda Maria Neves Dos Santos, Ilha (PT); Edgar Da Silva Ferreira, Bajouca (PT); Joana Teresa Varela De Lucena E Sampaio, Coimbra (PT); Paulo Jorge Mendes Santos, Coimbra (PT); Paulo Filipe Domingues Barbeiro, Marinha Grande (PT)

(21) Appl. No.: 12/996,175

(22) PCT Filed: Jul. 16, 2010
(86) PCT No.: PCT/PT10/00032

§ 371 Date: Aug. 19, 2011

Related U.S. Application Data
(60) Provisional application No. 61/226,494, filed on Jul. 17, 2009.

(30) Foreign Application Priority Data
Jun. 5, 2008 (PT) 104086

(51) Int. Cl. G06F 17/30

(52) U.S. Cl. 707/769; 707/E17.014

(57) ABSTRACT

A computer implemented method for inputting transient data into a persistent world is provided. The method includes capturing sensor data from a sensor. The method further includes detecting a condition, wherein the detection is based at least in part on the match of a detection criteria from a database of a plurality of detection criteria to the captured sensor data. The method includes interpreting the detected condition, wherein the interpretation is based at least in part on the match of an interpretation criteria from a database of a plurality of interpretation criteria to the detected condition. And, the method includes registering the interpretation of the detected condition with a virtual object in a simulation.

### TECHNICAL FIELD

The present disclosure relates generally to systems and methods relevant to input and processing of transient, real-world data. This input and processing of transient data is managed by a flexible, data-driven framework responsive to changes in the physical environment at a given time and over time. These systems and methods enable direct and indirect interaction between physical and virtual environments.

### BACKGROUND

At present, a number of interactive, simulated worlds exist for entertainment, social networking, social science modeling, marketing, engineering, and other purposes. Input into these systems from the physical world is typically limited to direct user input through limited mechanisms. For example, many simulated worlds only allow input from traditional user input devices such as keyboards, mice, and touch screens. Multimedia input is sometimes available, but typically in a limited way, e.g., adding a fixed image of a user to the user's avatar, which is controlled using the traditional user input devices listed above.

To the extent that input and processing of transient, real-world data, is possible such data is typically handled in a static or narrowly-defined way. For example, some systems utilize a camera to capture the position and/or movement of a person in order to translate physical information into a virtual representation. Other systems utilize a microphone to capture the spoken word in order to translate the captured audio into some form of computer instructions. These approaches tend to be overly narrow, literal, and inflexible.

### SUMMARY

In accordance with the teachings of the present disclosure, disadvantages and problems associated with approaches to inputting transient data have been reduced.

In certain embodiments, a computer implemented method for inputting transient data into a persistent world is provided. The method includes capturing sensor data from a sensor. The method further includes detecting a condition, wherein the detection is based at least in part on the match of a detection criteria from a database of a plurality of detection criteria to the captured sensor data. The method includes interpreting the detected condition, wherein the interpretation is based at least in part on the match of an interpretation criteria from a database of a plurality of interpretation criteria to the detected condition. And, the method includes registering the interpretation of the detected condition with a virtual object in a simulation.

In certain embodiments, software embodied in tangible computer-readable media is provided. The software is executable by a central processing unit to: capture sensor data from a sensor; detect a condition, wherein the detection is based at least in part on the match of a detection criteria from a database of a plurality of detection criteria to the captured sensor data; interpret the detected condition, wherein the interpretation is based at least in part on the match of an interpretation criteria from a database of a plurality of interpretation criteria to the detected condition; and register the interpretation of the detected condition with a virtual object in a simulation.

In certain embodiments, a computing system includes a central processing unit, a memory coupled to the central processing unit, and one or more software modules. The software modules are operable to capture sensor data from a sensor; detect a condition, wherein the detection is based at least in part on the match of a detection criteria from a database of a plurality of detection criteria to the captured sensor data; interpret the detected condition, wherein the interpretation is based at least in part on the match of an interpretation criteria from a database of a plurality of interpretation criteria to the detected condition; and register the interpretation of the detected condition with a virtual object in a simulation.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a system for inputting transient data into a persistent world, according to certain embodiments of the present disclosure;

FIG. 2 illustrates steps of a method for inputting transient data into a persistent world, according to certain embodiments of the present disclosure;

FIG. 3 illustrates a hierarchy of objects representing detections; and

FIG. 4 illustrates a hierarchy of objects representing interpretations.

### DETAILED DESCRIPTION

Certain non-limiting examples may aid the reader in understanding the present disclosure. These are presented first, and referenced again below with reference to the figures.

In a first example, a stream of audio music is continuously processed by the system, and a 3D bird is set on a branch, within a virtual world. When the level of the streamed audio music exceeds a threshold, the bird will then leave the branch and perform a circular pattern of flight for as long as the streamed music level is over the threshold.

In a second example, the system captures video and audio and generates two separate streams therefrom. Video is first scanned for circular patterns, and audio filtered for high pitches. A visual behavior of <<glowing>> is associated with each circle, and a behavior of <<repetition>> is associated with each high pitch. Sets of two concentric circles may be interpreted as <<eyes>>. A sonic behavior of <<wind chimes>> is associated to eyes. All of these objects (e.g., the circles, the eyes, and the occurrences of a high pitch) are then registered into a virtual world by a broker. As a result, a display of the virtual world will include glowing circles, and the sound of wind chimes in a parameterized range of eyes, and also high pitches played in a repeated fashion. For further clarity, because a person's eyes will only be recognized as concentric circles when open, a camera subject may cause wind chimes to be heard by opening her eyes in front of a camera, while closing her eyes may silence the chimes.

In a third example, system 100 is included as a component in an unmanned ground vehicle (UGV). System 100 receives streamed data from sonar array 117. Obstacles are first detected for sonar readings under a proximity value N. Such events are then interpreted as ‘dangerous’ when more than one array reports obstacles occurring over a 10-second period. A behavior is associated with ‘dangerous’ obstacles. This behavior could be a manifestation of the obstacle events in a virtual world, e.g., a virtual object with an assumed circular shape can be created as representation of said obstacle for use in collision detection routines. Alternatively, the behavior may include applying control signals to the vehicle's actuators in order to steer it in the opposite direction of the ‘dangerous’ objects, thereby avoiding obstacles in collision route to the UGV.

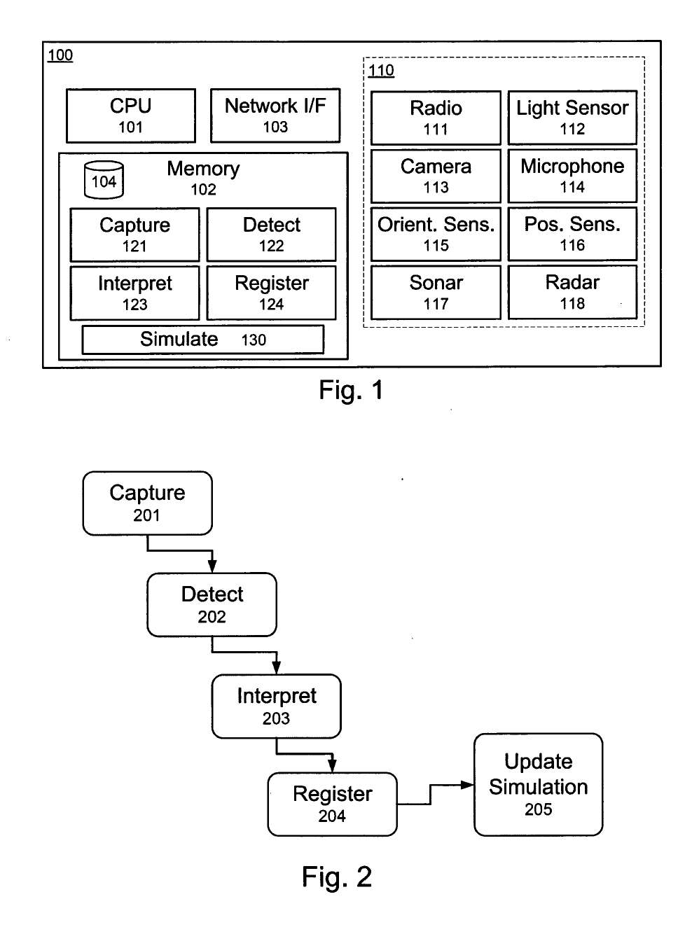

Preferred embodiments and their advantages over the prior art are best understood by reference to FIGS. 1-4 below.

FIG. 1 illustrates a system for inputting transient data into a persistent world, according to certain embodiments of the present disclosure. System 100 may include computing device 110, which may include central processing unit (CPU) 101, memory 102, network interface 103, database 104, and input devices 110. Memory 102 may include various programming instructions including capture module 121, detection module 122, interpretation module 123, registration module 124, and simulation module 130.

System 100 is a computing device embodying, in whole or in part, the present invention. System 100 may be, for example, a mobile phone, personal digital assistant (PDA), smart phone, netbook, laptop computer, dedicated device, or digital camera. In some embodiments, system 100 is continuously and automatically performing the presently disclosed methods. In other embodiments, the user manually activates one or more of the presently disclosed methods. System 100 may include a number of components as integral components or as peripheral components. These components are identified and described as follows.

Central processing unit (CPU) 101, or processor, enables the execution of local software and the interaction of various other components. CPU 101 may be one or more microprocessors or microcontrollers capable of executing programmed software instructions. CPU 101 may be, for example, an ARM-based processor, a MIPS-based processor, or an X86 compatible processor. CPU 101 may be a low-power, embedded processor or microcontroller.

Memory 102 stores software instructions and data for use by CPU 101 and/or other components of system 100. Memory 102 may be one or more of the following types of tangible computer-readable media, e.g., RAM, ROM, EPROM, flash memory, magnetic storage, or optical storage. Memory 102 may also include a combination of memory types. Memory 102 may be volatile, non-volatile, or include both volatile and non-volatile technologies.

Network interface 103 provides connectivity to remote systems 100 and/or peripheral devices. Network interface 103 may be, for example, Ethernet, WiFi, WiMax, GSM, CDPD, Bluetooth, wireless USB, short message service, or a two-way pager. Network interface 103 may be a wired or wireless connection and may be continuously available or intermittent.

Database 104 provides structured storage of relevant data for performing the presently disclosed methods. Database 104 may include a set of detection criteria, interpretation criteria, object types, and behaviors. Database 104 may include hierarchies of detection criteria wherein a search may include a specific and a general match. Database 104 may include hierarchies of interpretation criteria wherein a search may include a specific and a general match. Database 104 may include hierarchies of behaviors wherein a search may include a specific and a general match.

Input devices 110 provide input from the physical world for the methods described herein. Input devices may include one or more of radio receiver 111, light sensor 112, camera 113, microphone 114, orientation sensor 114, position sensor 116, sonar receiver 117, and radar receiver 118.

Radio receiver 111 provides reception of data from a radio frequency transmitter in order to capture a transmitter identifier for that transmitter, which may provide location identifying information. Radio receiver 111 may be, for example, a cell phone interface, an RFID reader, or any of the wireless networking technologies listed with reference to network interface 103. Further, radio receiver 111 may not be necessary if network interface 103 supports one or more wireless protocols and can provide this information to system 100. In some embodiments, radio receiver 111 may receive and identify another mobile device within radio transmission range, e.g., another user's cell phone SIM information.

Light sensor 112 provides reception of intensity and/or color information. Light sensor 112 may be one or more of, for example, a photoresistor, photodiode, charged coupled device, or CMOS light detector. Light sensor 112 may incorporate one or more light filters to detect color information from a target light source.

Camera 113 allows system 100 to capture still images or video at the user's location. Camera 113 may be an integral camera element, e.g., embedded in a camera phone or smart phone, or may be a peripheral device connected to system 100. Camera 113 may have sufficient resolution, image quality, and light sensitivity to allow identification of identifying characteristics of the subject of the photograph. For example, in some embodiments, camera 113 may be a low resolution, black and white camera, designed to capture general shapes and movement. In other embodiments, camera 113 may be a high-resolution, color camera, capable of taking a clear picture of a person or object. The captured image may be sufficiently detailed and clear to allow an image recognition module to identify the subject of the photograph, e.g., a person or identifiable object. Camera 113 may provide further information such as the field of view, depth of view or calculated range to subject.

Microphone 114 allows system 100 to capture audio from the user's location. Microphone 114 may be an integral element, e.g., the microphone in a mobile phone handset, or a peripheral device connected to system 100. Microphone 114 may capture monaural or stereophonic sound. In some embodiments, microphone 114 may be combined with a speech recognition unit to recognize announcements made in mass transit vehicles, government buildings, and museums. Thus microphone 114 may capture an announcement of “Palais Royal” or “Aldwych” that may be interpreted by CPU 101 to identify a train station in Paris or London, respectively. In some embodiments, microphone 114 may record background or ambient sounds.

Orientation sensor 115 provides information about the present orientation of system 100. Orientation sensor 115 may be a compass, inclinometer, gyro-enhanced orientation sensor. Orientation sensor 115 may incorporate accelerometers and magnetometers. Position sensor 116 provides information about the present position of system 100. Position sensor 116 may be a global positioning system (GPS) unit. Sonar 117 provides information about reflections of sound waves for determining position and movement information relating to objects in front of sonar 117. Radar 118 provides information about reflections of microwave radiation for determining position and movement information relating to objects in front of radar 118.

Capture 121 is a module for performing the capture step 201. Detect 122 is a module for performing detect step 202. Interpret 123 is a module for performing interpret step 203. And, register 124 is a module for performing register step 204. Simulate 130 is a module for executing a simulation, e.g., a multi-user, social networking simulation. These modules may be running on more than one system 100.

FIG. 2 illustrates steps of a method for inputting transient data into a persistent world, according to certain embodiments of the present disclosure. Method 200 includes steps of capture 201, detect 202, interpret 203, register 204, and update simulation 205. In some embodiments, one or more of these steps is performed on one system 100, while at least one other step is performed on a different system 100, e.g., in communication with the first system 100 via network interfaces 103.

At a high level, method 200 connects a physical world with a simulation of a virtual world. The current state of the simulation may then be reflected in the physical world by way of a visual display, audio transmission, generation of smells, actuation of mechanical components, or other feedback mechanisms. The physical world may include one or more areas of interest, which are within range of input devices 110.

Capture 201 generates digital data streams based at least in part on data received from input devices 110. Capture 201 may perform an analog to digital conversion of data received from input devices 110. Capture 201 may apply certain filters or threshold analysis to restrict the digital data stream to relevant or potentially relevant data.

Capture 201 may be illustrated with reference to the three examples presented above. In the first example, capture 201 may request a stream of audio values from microphone 114. Capture 201 may convert an analog audio stream into digital values. In the second example, capture 201 may request an audio stream from microphone 114 and also request a video steam from camera 113. In the third example, capture 201 may request a stream of sonar data from sonar 117. This sonar data may be converted into digital frames, much like an image file. In some embodiments, the sonar data may result in a stream of position and intensity readings.

In the third example, capture 201 may apply an intensity filter and an object size filter to the sonar data produced by sonar 117 to eliminate noise. Capture 201 may output a series of two-dimensional images of strong, broad registration signals.

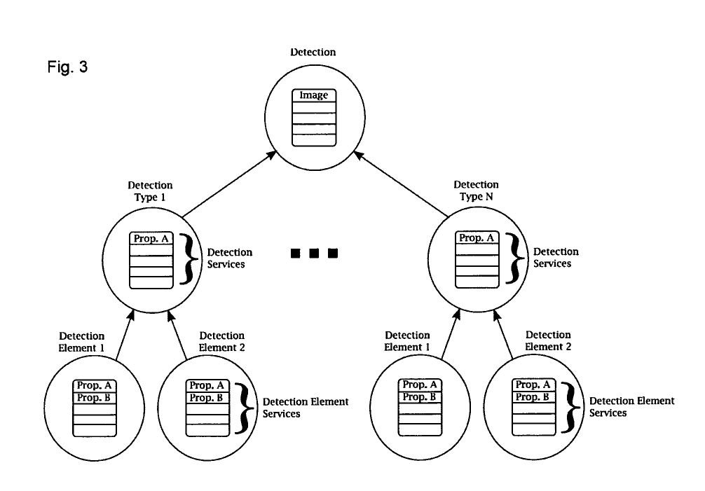

Detect 202 extracts sets of relevant patterns from the digital data streams. These patterns are arranged into a first taxonomical classification, described in reference to FIG. 3, below, and stored in database 104. In one example, video frames may be decomposed into vertical lines, horizontal lines, motion patterns, and/or color patterns. In another example, an audio stream may be decomposed into intensity or pitch values, or signature audio patterns may be identified. Detect 202 may be performed by matching detection criteria from database 104 with data in the data streams. Detect 202 may be illustrated with reference to the three examples presented above.

In the first example, detect 202 may translate the audio stream from capture 201 into a series of integer values representing a spot intensity values, for example ranging from 1 to 100. Alternatively, detect 202 may generate a series of floating point values representing the running-average or windowed average intensity value measured in decibels. In some embodiments, detect 202 generates a Boolean value on a sound object where, for example, a logical “1” indicates that the audio data stream has met or exceeded a predetermined threshold intensity level for an interval of time and a logical “0” indicates that the audio data stream is below the threshold intensity.

In the second example, detect 202 may apply one or more graphical filters to frames of a digital video stream produced by camera 113. Detect 202 may, for example, convert color data into grayscale values or black and white values. Detect 202 may apply a contrast filter. Detect 202 may apply a color filter. In some embodiments, detect 202 may produce more than one two-dimensional image, each resulting from the application of a different filter or series of filters applied to it. For example, one output image may be high-contrast black and white while the second output image may be a sharpened, grey-scale image. Once detect 202 has filtered and processed the image data, detect 202 may identify basic patterns, shapes, and/or regions. Detect 202 performs a searching algorithm, e.g., a circular Hough transform, to identify any circles in the image. For each identified circle, detect 202 creates a circle object in memory 102 and sets the relevant properties. For example, each corresponding circle object may have a property indicating a two or three-dimensional coordinate value of the center of the respective circle. The corresponding circle object may also have a scalar property representing the radius of the circle.

Because there is an accompanying audio stream, detect 202 may generate a series of integer values representing the pitch of the audio stream. Detect 202 may translate the audio data stream into a Boolean value on a sound object where, for example, a logical “1” indicates that the audio data stream has met or exceeded a threshold pitch level for an interval of time and a logical “0” indicates that the audio data stream is below the threshold pitch.

In the third example, detect 202 may filter out sonar registrations smaller than a predetermined threshold intensity or size. For each sonar registration remaining, detect 202 creates a sonar registration object. In some embodiments, detect 202 sets a distance property on each object to indicate the distance to that object from the observation point. In some embodiments, detect 202 sets a position property indicating an absolute position of the sonar registration object on a coordinate system.

Interpretation 203 generates a higher-level classification of data detected in detection 202. For each interpreted event, interpretation 203 generates at least one logical object and at least one associated behavior. For example, if the input source is video, interpretation 203 may identify faces, trees, buildings, and/or constructions. If the input source is audio, interpretation 203 may identify rhythm, noise, voices, and/or music. Interpretation 203 may be an iterative or multilayered process. In some embodiments, interpretation 203 may be performed by matching interpretation criteria from database 104 with data in the data streams. In some embodiments, interpretation 203 may be performed by executing software routines stored in interpret 123 and/or database 104.

Interpretation 203 may rely on information stored regarding earlier values of input data. For example, an interpretation of an error condition may be made based on a sequence over time of high pitched beeping sounds. In another example, interpretation 203 of person, which is now partially obscured by different object, may rely on a prior interpretation from a video frame in which the person was not obscured. In this example, the interpretation of the obscured person may rely in part on a previously generated interpretation object. Interpretation 203 may be literal or non-literal. A literal interpretation may be one in which an interpretation object is somewhat representative of a sensed condition or object, e.g., an interpretation object representing a person at a particular location. An example of a non-literal interpretation is the creation of a wind chime object in response to the detection of concentric circles in a person's eyes. Interpretation 203 may be illustrated with reference to the three examples presented above.

In the first example, interpret 203 monitors the audio threshold of the audio stream and associates one of two behaviors with a corresponding object, in this case, a bird. The first behavior, corresponding to a below-threshold audio level, is for the bird to remain on a branch. The second behavior, corresponding to an above-threshold audio level, is for the bird to fly in a circle overhead.

In the second example, interpret 203 creates a visual circle object for each detected circle with a behavior of <<glowing>>. Interpret 203 also identifies concentric circles, e.g., those with roughly common center points. For each concentric circle, interpret 203 creates an eye object and associates a behavior of <<wind chimes>>. In this way, a person's eyes may each be interpreted by interpret 203 as two glowing concentric circles and one set of wind chimes. Further, interpret 203 may also be monitoring an audio stream for occurrences of high pitches. Upon such an occurrence, each circle and each eye object may be additionally associated with a <<repetition>> behaviour. Thus a user playing a violin at a high pitch may be visualized as a pair of repeatedly glowing circles associated with repeatedly ringing wind chimes.

In the third example, interpret 203 searches through the sonar registrations from at least two sonar arrays 117. For each identified obstacle, an object is created with a property indicating the distance to that obstacle and property indicating the registering sonar array. When interpret 203 identifies two or more sufficiently close obstacles reported by different sonar arrays, interpret 203 classifies each close obstacle as dangerous and associates avoidance behavior with the vehicle object.

Register 204 registers into a simulation all objects created by interpret 203 along with their associated behaviors. Behaviors can be associated with objects of the first and/or the higher categories, as well as with any other level of categorization, and the behaviors can themselves be arranged in a hierarchy. Behaviors may be tags for referencing behavior instructions within the simulation or may be defined in detail as associated by interpret 203. Register 204 provides a synchronization between interpret 203 and the real-time simulation to prevent data corruption or errant behavior. In one example, new objects can only be introduced by register 204 after a rendering operation has completed and before another has begun. Register 204 may be illustrated with reference to the three examples presented above. In each example, the newly created objects (e.g., the bird, the circles, the wind chimes, and the hazardous objects) are introduced into the simulation. For example, a user will see the bird sitting on a tree until the sound intensity rises to a certain level. Then, the user will see the bird take flight and circle until the sound intensity drops off.

FIG. 3 illustrates a hierarchy of objects representing detections. A detection may result in the creation of a single detection object or multiple detection objects. For example, a person captured by camera 113 may result in the following detections. Detection type 1 may be a facial detection looking for a collection of image features that appear to represent a face. Prop. A of Detection Type 1 may be a count of identified faces and associated Detection services may allow interpret 203 to operate on Detection Type 1 and/or its children.

Detection Element 1 may represent a first detected face. Property A may represent the position of the first detected face. Property B may contain the image information captured for the first detected face. Likewise, Detection Element 2 may represent a second detected face. Detection Element Services may provide methods for accessing and manipulating relevant underlying data, including the underlying image information.

Detection Type N may be a polygonal detection looking for polygons to represent solids extracted from the captured image. Detection Element 1 may be an oblong polygon representing the first person's arm while Detection Element 2 may be another polygon representing the first person's torso. In some embodiments, a portion of the captured image may result in multiple detection elements. For example. A person's face may be associated with a circular polygon for each eye, an oval polygon for the person's head, and a face detection element.

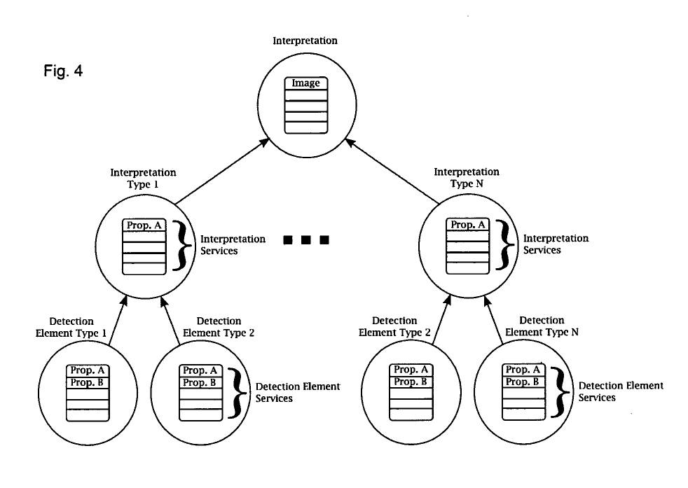

FIG. 4 illustrates a hierarchy of objects representing interpretations. An interpretation may result in the creation of a single interpretation object or multiple interpretation objects. For example, Interpretation Type 1 may be a person interpretation with Property A representing the person's name, e.g., “Bob.” The person's name may be manually associated or automatically identified from a database of identities. Bob actually has, and each has been detected, a torso represented by Detection Element Type 1 and a face represented by Detection Element Type 2. Likewise, Bob may have also be interpreted to be a threat, e.g., represented by Interpretation Type N, based at least in part on his face matching that of a wanted criminal. Detection element Type N may represent a polygon in Bob's possession that may have been interpreted to be a weapon, e.g., a bat or club.

The embodiments described herein may operate in parallel and autonomously. This data consistency and synchronization must be maintained. Modularization may also be critical to allow modification of one portion of the system without requiring modification of the remaining system.

The data consistency in parallel tasks may be solved by the use of a functional approach in which data processing is encapsulated in tasks. Tasks may be chained together in a way that the output of one task may be connected to the input of one or more subsequent tasks. Each task may not modify input data and must always generate new output data. In this way, data is ensured to be consistent for each call to any given task.

The modular composition and execution of behaviors may be achieved through implementation of a behavior tree. In this way, behaviors may all conform to a pre-specified common interface, and are arranged in hierarchical fashion such that a leaf behavior represents a concrete task and a composite behavior represents a way to control the execution of its children. It may be possible to replace both the leaf behaviors and composition strategies without compromising reusability of any other behaviors in the system, thus modularity is ensured.

The modular composition of persistent data may be achieved via the Inversion of Control design pattern, more specifically using a Service Locator. In this pattern, persistent data is assembled via collections of modular components. Dependencies between components are resolved by access to a service provider (i.e., the Service Locator) which abstracts access to these dependencies such that both the concrete implementation of the dependency and the way in which the dependencies are accessed can be easily replaced, thus ensuring that each component implementation is modular, even in regards to used dependencies.

For the purposes of this disclosure, the term exemplary means example only. Although the disclosed embodiments are described in detail in the present disclosure, it should be understood that various changes, substitutions and alterations can be made to the embodiments without departing from their spirit and scope. Moreover, while certain modules are described and referenced in the claims, one of ordinary skill in the art would understand that the specific grouping of functions in one or modules should not be seen as required or limiting unless accompanied by clear, unambiguous language to that effect.

1. A computer implemented method for inputting transient data into a persistent world, the method comprising:
capturing sensor data from a sensor;
detecting a condition, wherein the detection is based at least in part on the match of a detection criteria from a database of a plurality of detection criteria to the captured sensor data;
interpreting the detected condition, wherein the interpretation is based at least in part on the match of an interpretation criteria from a database of a plurality of interpretation criteria to the detected condition;
registering the interpretation of the detected condition with a virtual object in a simulation.

2. The computer implemented method of claim 1, wherein the plurality of interpretation criteria includes both literal and non-literal interpretation criterion.

3. The computer implemented method of claim 1, wherein the sensor includes at least one of a camera, a light sensor, a microphone, a sonar receiver, a radar receiver, a radio receiver, a pressure sensor, a touch pad, a position sensor, and an orientation sensor.

4. The computer implemented method of claim 1, wherein interpreting the detected condition includes matching another interpretation criteria from the database of interpretation criterion with a previously determined interpretation value.

5. The computer implemented method of claim 1, wherein registering the interpretation includes registering a behavior and data associated with the interpretation.

6. The computer implemented method of claim 5, wherein the behavior includes instructions for implementing the behavior.

7. The computer implemented method of claim 1, further comprising interpreting the detected condition a second time, wherein the second interpretation is based at least in part on the match of a second interpretation criteria from the database of interpretation criteria to the detected condition.

8. The computer implemented method of claim 1, wherein interpreting the detected condition is further based at least in part on the match of the interpretation criteria with a value generated from a prior interpretation.

9. The computer implemented method of claim 5, wherein:
a query of a database of behaviors based on the interpretation resulted in a plurality of matching behaviors; and
the behavior registered with the interpretation is the most specific of two behaviors.

10. Software embodied in tangible computer-readable media and, when executed by a central processing unit, operable to:
capture sensor data from a sensor;
detect a condition, wherein the detection is based at least in part on the match of a detection criteria from a database of a plurality of detection criteria to the captured sensor data;
interpret the detected condition, wherein the interpretation is based at least in part on the match of an interpretation criteria from a database of a plurality of interpretation criteria to the detected condition; and
register the interpretation of the detected condition with a virtual object in a simulation.

11. A computing system comprising:
a central processing unit;
a memory coupled to the central processing unit; and
one or more software modules operable to:
capture sensor data from a sensor;
detect a condition, wherein the detection is based at least in part on the match of a detection criteria from a database of a plurality of detection criteria to the captured sensor data;
interpret the detected condition, wherein the interpretation is based at least in part on the match of an interpretation criteria from a database of a plurality of interpretation criteria to the detected condition; and
register the interpretation of the detected condition with a virtual object in a simulation.
